(19) United States
(12) Patent Application Publication
(10) Pub. No.: US 2008/0001775 A1
(43) Pub. Date: Jan. 3, 2008

(54) APPARATUS AND METHOD FOR MEMORY DUMP AND/OR COMMUNICATION FOR MWD/LWD TOOLS

(75) Inventors: Frank Wiese, Lachendorf (DE); Rene N. Ritter, Celle (DE)

Correspondence Address: CANTOR COLBURN, LLP, 55 GRIFFIN ROAD SOUTH, BLOOMFIELD, CT, 06002, US

(73) Assignee: BAKER HUGHES INCORPORATED, Houston, TX (US)

(21) Appl. No.: 11/763,501

(22) Filed: Jun. 15, 2007

Related U.S. Application Data
(60) Provisional application No. 60/818,043, filed on Jun. 30, 2006.

(51) Int. Cl. G01V 3/00

(52) U.S. Cl. 340/853.1

(57) ABSTRACT

A MWD/LWD bottom hole assembly including a housing and a window at the housing, the window being transmissive to the signal of at least one transceiver of a tool having a memory in operable communication with the transceiver, such that the signal is receivable outside of the housing through the window. A method for downloading MWD/LWD data to a surface computer. The method includes wirelessly communicating collected data from a MWD/LWD tool memory to a transceiver external to the tool; passing data through the external transceiver, the transceiver further transmitting the data; and receiving data at the surface computer.

### CROSS REFERENCE

The present application claims priority to U.S. Provisional Patent Application Ser. No. 60/818,043, filed Jun. 30, 2006, the entire contents of which are specifically incorporated herein by reference.

### BACKGROUND

Measurement while drilling (MWD) and logging while drilling (LWD) tools are ubiquitously used in the hydrocarbon exploration and production (E&P) industry because these devices and their use optimizes drilling efficiency and precision thereby improving returns on initial investment. Greater returns are realized through reduced downtime reduced corrective measures, such as drilling angle, and avoidance of equipment damage.

One drawback associated with the use of MWD and LWD tools is the limited bandwidth for providing accumulated data to surface computers in need thereof. In some cases, where the tool is tripped to surface, the tool itself must be opened at one or more locations which is time consuming and potentially damaging to the tool in view of the fluids in which the tool is bathed during residence in the well.

Faster and more reliable methods for downloading information accumulated downhole and/or bi-directional communication to surface computers are always well received by the art.

### SUMMARY

A MWD/LWD bottom hole assembly including a housing and a window at the housing, the window being transmissive to the signal of at least one transceiver of a tool having a memory in operable communication with the transceiver, such that the signal is receivable outside of the housing through the window.

A method for downloading MWD/LWD data to a surface computer. The method includes wirelessly communicating collected data from a MWD/LWD tool memory to a transceiver external to the tool; passing data through the external transceiver, the transceiver further transmitting the data; and receiving data at the surface computer.

### BRIEF DESCRIPTION OF THE DRAWINGS

Referring now to the drawings wherein like elements are numbered alike in the several figures:

FIG. 1 is a schematic view of one embodiment of a MWD/LWD tool assembly 10, also commonly referred to as bottom hole assembly (BHA), as disclosed herein.

### DETAILED DESCRIPTION OF THE DRAWINGS

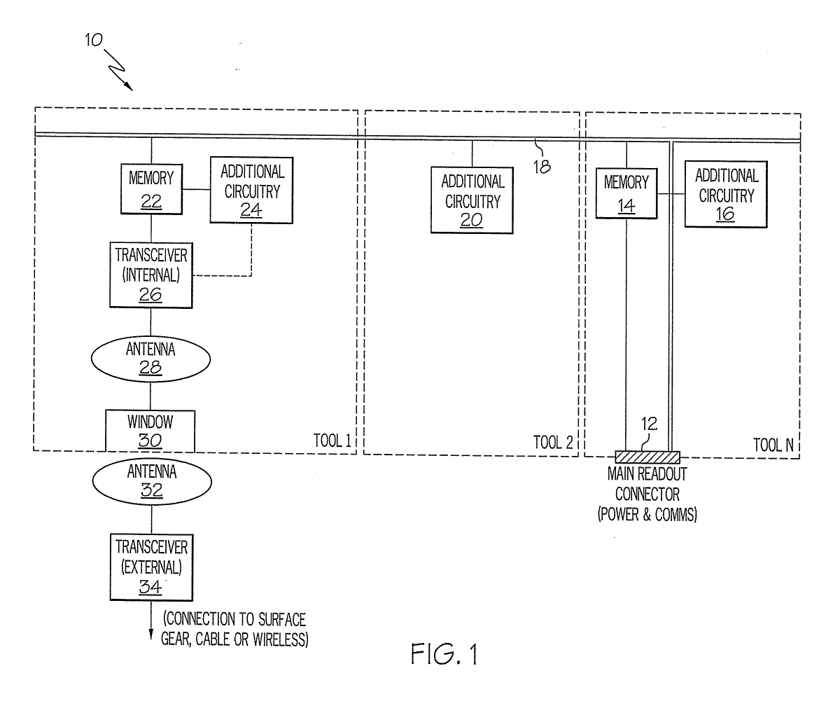

Referring to FIG. 1, a BHA 10 is schematically illustrated to provide a frame of reference for the description following herein.

It will be appreciated by one of skill in the art that MWD/LWD tools generally contain a number of functional groups of electrical devices that each perform a specific function thereby generating their own volumes of data for reporting at the surface. Due to the high amount of data generating electronics in the BHA, often there is not enough bandwidth available for download of the various tool memories. Rig time, as is well known, is available at not insubstantial expense and is therefore desirably temporally reduced when possible. One way to reduce rig time is to speed the data dump from the MWD/LWD tool to surface computer(s). While this is of course desirable, it is not desirable to open a plurality of ports into the tool because of potential contamination and in addition simply the time it takes to clean the area of the tool surrounding the access opening and physically remove a cover.

Each of these considerations is addressed by the MWD/LWD tool arrangement disclosed herein. Referring again to FIG. 1, the schematic tool 10 includes one main readout connector 12 for power and communication. This connector 12 is an openable cover in one embodiment to provide power to the tool in a most expeditious way. It is noted however that wireless arrangements and methods as discussed hereunder could also be employed to provide power.

It will be appreciated from review of FIG. 1 that the main readout connector 12 is in operable communication with a memory 14 and additional circuitry 16 inside of tool “N”. It will be appreciated that “N” is utilized herein to signify any numerical designation associated with a potential number of tools. While only three tools are illustrated working together in FIG. 1, any number of tools is possible, hence the designation “tool N”. Memory 14 and additional circuitry 16 are in selective operable communication through BHA internal bus 18 with other MWD/LWD related electronics in tools 1 and 2 such as additional circuitry 20 (illustrated in tool 2, for example) and memory 22 and additional circuitry 24 (illustrated, for example in tool 1).

As alluded to above, if each volume of memory/data needed to be dumped through the main readout connector 12, all said memory/data would have to be bussed along BHA internal bus 18 to the readout connector 12 from the other components of the MWD/LWD tool 10. Clearly this presents a bottleneck situation.

Illustrated as a portion of tool 1 (again, only by example, as the components may be placed at any or all of the tools of the MWD/LWD tool 10) is a transceiver 26 in operable communication with memory 22. While lines are utilized to signify operable communication between schematic blocks of the figure, it is to be understood that each of the lines indicating connection on FIG. 1 may be wired or wireless connections utilizing electric signal, optical signal, hydraulic signal, acoustic signal, etc. as appropriate in the specific application. It is further to be understood that applicants have no intent to limit the operable connection between the various components to hard wired connections.

Operably communicating with transceiver 26 is an antenna 28 that is capable of propagating a wireless signal that is receivable by another antenna 32 some distance from antenna 28. It is by means of the wireless communication between antennas 28 and 32 that a benefit of the invention described herein is achieved. The term antenna is broadly used herein to include not only electromagnetic signal propagation but also to mean a device capable of transmitting and receiving the signal contemplated. For example. Where infrared (IR) is the signal type, a light emitting diode (LED) would be the “antenna” to transmit the IR signal. Further, while the antenna is illustrated as a separate component from that of the transceiver, it is to be understood that the antenna may form a part of the transceiver in some embodiments. Because of the wireless communication capability, it becomes possible to dump memory from the various components of the tools without the need to open the MWD/LWD tool 10. In order to facilitate this transfer of data from antenna to antenna, provision is required in the housing of tool 10 to allow transmission of the selected signal type through that housing. For this purpose, a window 30 is provided in the tool 10 housing, which window is pressure sealed to the housing, and transmissive to the selected signal type. In the event, for example, the signal type is electromagnetic (EM) wave, the window may be of any type of material that will not significantly attenuate the EM signal such as plastic, low carbon materials and most non-metals. In the alternative event that infrared (IR) is the transmission signal of choice, for example, the window 30 may be glass or other material transmissive to IR light. Other materials are also suitable providing they do not significantly attenuate the selective signal type. Acoustic transmission is also contemplated with window 30 being sufficiently flexible to facilitate propagation of the acoustic signal without significant attenuation. In the case of acoustic signal transmission (e.g. ultra-sonic) the window itself could be an acoustic transmitter (e.g. a piezo-crystal, which is electrically excited). In this particular case, the window could also be an antenna according to the definition noted above. The window 30 must also be constructed with sufficient strength (e.g. thickness, etc.) to withstand the downhole pressure differential between the environment inside and outside of the tool 10.

Antenna 32 is in operable communication with external transceiver 34 which is in turn configured to provide operable pass through communication with a surface computer(s) via wired or wireless connection as desired. While only one antenna-antenna interface is illustrated in tool 10 in FIG. 1, it is to be understood that any number of these may be utilized creating the potential for functionality ranging from one interface for the whole tool through and including an individual interface for each component of the tool and any combination of possibilities therebetween.

It is important to note that one of the advantages of the configurations described herein is that there is no intermediate memory required between the individual tool memories and the ultimate surface computer memories. That is to say the external transceiver does not contain a memory but rather passes through information in real time relative to the dump process from the tool memory. This provides for a faster data dump to the surface computer(s) and eliminates potential memory corruption at an intermediate step. The process disclosed herein is thus faster and less prone to corruption than any device of the prior art.

In one iteration of the use of the configuration and method of the disclosed invention, an antenna/transceiver 32/34 assembly may be “strapped” or otherwise maintained in register with a window 30 immediately as the window exits the borehole. Where sufficient power is available, data may immediately begin to flow from this connection before even the balance of the tool 10 is removed from the borehole. Similar antenna/transceiver assemblies may be “strapped” or otherwise maintained in register with other windows 30 of the tool 10 as they exit the borehole. The additional assemblies may employ the same or different transmission types and while the same type may even employ the same frequency, a greater rate of data transmission overall for the BHA 10 can be achieved with differing frequencies, encoding types, modulation schemes, etc. This provides for very rapid communication of information, reduces downtime of the well, maximized effectiveness of rig time and is therefore a most efficient process.

In yet a further utility of the disclosed arrangement and method, the wireless transceivers are employable to communicate to systems other than the surface computers to which they, in the above embodiments, have been disclosed to dump. For example, the transceivers may also be employed to wirelessly communicate from component to component or tool module to tool module within BHA 10. Further the transceiver(s) may be utilized with other downhole tools or with permanently installed devices in the wellbore.

While preferred embodiments have been shown and described, modifications and substitutions may be made thereto without departing from the spirit and scope of the invention. Accordingly, it is to be understood that the present invention has been described by way of illustrations and not limitation.

1. A MWD/LWD bottom hole assembly, comprising:
a housing
at least one MWD/LWD tool at the housing, the tool including:
at least one memory at least one transceiver in operable communication with the at least one memory, the transceiver productive of a signal; and
a window at the housing, the window being transmissive to the signal of the at least one transceiver such that the signal is receivable outside of the housing through the window.

2. The MWD/LWD assembly as claimed in claim 1 wherein the tool further comprises at least one antenna in operable communication with the transceiver and capable of broadcasting the signal of which the window is transmissive.

3. The MWD/LWD assembly of claim 1 wherein the window is pressure sealed to the housing.

4. The MWD/LWD assembly as claimed in claim 1 wherein the window is plastic.

5. The MWD/LWD assembly as claimed in claim 1 wherein the window is glass.

6. The MWD/LWD assembly as claimed in claim 1 wherein the window is nonmetallic.

7. The MWD/LWD assembly as claimed in claim 1 wherein the window is acoustic wave transmissive.

8. The MWD/LWD assembly as claimed in claim 1 wherein the window is optically transmissive.

9. The MWD/LWD assembly as claimed in claim 1 wherein the window is electromagnetically transmissive.

10. The MWD/LWD assembly as claimed in claim 1 wherein the signal is electromagnetic.

11. The MWD/LWD assembly as claimed in claim 1 wherein the signal is optical.

12. The MWD/LWD assembly as claimed in claim 1 wherein the signal is acoustic.

13. A MWD/LWD assembly and external data transmission assembly comprising the tool as claimed in claim 1 and further including an external transceiver registerable with the window and receptive of the signal, the external transceiver being further in wireless communication with a surface computer.

14. The MWD/LWD tool and external data transmission assembly as claimed in claim 13 wherein the external transceiver is in wired communication with a surface computer.

15. The MWD/LWD tool and external data transmission assembly as claimed in claim 13 wherein the external transceiver is a pass-through transceiver having no resident memory.

16. The MWD/LWD tool and external data transmission assembly as claimed in claim 13 wherein the external transceiver is registerable with the window without opening the housing.

17. The MWD/LWD tool and external data transmission assembly as claimed in claim 13 wherein the wireless communication with the surface computer occurs at a frequency, encoding type, modulation scheme, etc. different than the frequency, encoding type, modulation scheme, etc. at which communication between the internal transceiver and external transceiver occurs.

18. The MWD/LWD tool and external data transmission assembly as claimed in claim 13 wherein the wireless communication with the surface computer occurs on a different signal type than the type on which communication between the transceiver and external transceiver occurs.

19. A method for downloading MWD/LWD data to a surface computer comprising:
wirelessly communicating collected data from a MWD/LWD tool memory to a transceiver external to the tool;
passing data through the external transceiver, the transceiver further transmitting the data;
receiving data at the surface computer.

20. The method for downloading MWD/LWD data as claimed in claim 19 wherein the external transceiver is hard wired to the surface computer.

21. The method for downloading MWD/LWD data to a surface computer as claimed in claim 19 wherein the further transmitting is wireless.

22. The method for downloading MWD/LWD data to a surface computer as claimed in claim 19 wherein the communicating is electromagnetic.

23. The method for downloading MWD/LWD data to a surface computer as claimed in claim 19 wherein the communicating is acoustic.

24. The method for downloading MWD/LWD data to a surface computer as claimed in claim 19 wherein the communicating is optical.
